(19) United States
(12) Patent Application Publication
(10) Pub. No.: US 2006/0012079 A1
(43) Pub. Date: Jan. 19, 2006

(54) Formation of a self-assembled release monolayer in the vapor phase

(76) Inventors: Gun-Young Jung, Mt View, CA (US); Yong Chen, Sherman Oaks, CA (US); R. Stanley Williams, Redwood City, CA (US); Sivapackia Ganapathiappan, Los Altos, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/893,082

(22) Filed: Jul. 16, 2004

(51) Int. Cl. B28B 7/36; B29C 33/58

(52) U.S. Cl. 264/338; 427/248.1

(57) ABSTRACT

A method is provided for coating a surface having features thereon with a self-assembled monolayer for aiding release of the surface during an imprinting procedure. The method comprises exposing the surface to a vapor of a mold release agent.

### TECHNICAL FIELD

The present invention is directed to release layers, such as used in nano-imprint lithography, micro electrical-mechanical devices (MEMs), and template stripping, and, more particularly, to release layers for molds used in nano-imprint lithography.

### BACKGROUND ART

Nano-Imprint lithography was initiated as an alternate process to achieve nanoscale features (100 nm or smaller) with high throughput and low cost. The nanoscale structures are transferred from a mold to polymer layer during the imprinting process. The mold may be used for the thermal imprint process as well as the UV-based imprint process.

In the case of the thermal imprint process, to deform the shape of the polymer, the temperature of the film and mold should be higher than the glass transition temperature of the polymer, so that the polymer flows more easily to conform to the shape of the mold. By pressing the mold into the polymer film using hydrostatic pressure, a replica of the mold is formed in the polymer layer. The press is then cooled below the glass transition temperature to “freeze” the polymer and form a more rigid copy of the features in the mold, and the mold is then removed from the substrate.

In the case of the UV imprint process, this alternative process uses a UV-curable monomer solution instead of a thermoplastic polymer. The monomer layer is formed between the mold and the substrate. Upon shining UV light on the monomer layer, it is polymerized to form a robust film with the desired patterns on it. The UV-based nanoimprint process can generate patterns at room temperature with low pressure.

A possible problem with these techniques is the adhesion of the polymer to the mold. If the polymer sticks to the mold, then the imprinted pattern and/or the mold itself may be damaged by pulling the mold off the substrate. This can ruin the imprinted patterns or, worse, destroy the mold (which may be very expensive and time-consuming to produce).

To reduce the adhesion of the polymer to the mold, self-assembled monolayers (SAMs) formed from organosilane release agents have been attached to the surface of the mold by immersing the mold in a solution of the release agent at a concentration of, for example, 1×10⁻⁴ M. The improved release properties allow for the enhancement of pattern resolution in the polymer film. By “release property” is meant how well the mold can be detached from the polymer layer after imprinting without the polymer sticking to the mold.

If the release properties are not good enough, the polymer can fill the openings or partially fill the openings of the mold, which means that the mold must be cleaned thoroughly between each use and that the process becomes very slow, or, worse, a piece of the mold may break away during separation, thus permanently damaging the mold.

The solution-based coating process depends on temperature, the presence of water, the nature of the solvent, and the concentration of the coupling agent, which complicates the actual performance and understanding of the process. Moreover, solution-based procedures for forming the SAM release layer do not work well for extremely small feature sizes or large aspect ratios because of surface tension issues (bubble formation on the surface of the mold, for example). This leads to highly non-uniform coverage of the mold by the release agent and the types of problems noted above.

Thus, there is a need to provide a mold release layer for nanoimprinting that avoids most, if not all, of the foregoing problems.

### DISCLOSURE OF INVENTION

In accordance with the embodiments disclosed herein, a method is provided for coating a surface having features thereon with a self-assembled monolayer for aiding release of that surface during an imprinting procedure. The method comprises exposing the surface to a vapor of a release agent precursor.

Further in accordance with the embodiments disclosed herein, a method is provided for coating the nano-imprint mold with the self-assembled monolayer for aiding release of the mold during an imprinting procedure. The process comprises:
hydroxylating the mold surface;
exposing the mold to a vapor of a release agent precursor;
hydrolyzing the release agent to form a hydrolysis product; and
condensing the hydrolysis product on a surface of the mold.

Still further in accordance with the embodiments disclosed herein, the mold is provided with a release coating comprising the self-assembled monolayer on a surface of the mold.

### BRIEF DESCRIPTION OF THE DRAWINGS

FIG. 1 is a side elevational view of a mold having features and immersed in a solution of a mold release agent;

FIG. 2 schematically depicts an embodiment of the process for applying a release agent onto a surface of the mold; and

FIG. 3 schematically depicts an example of an apparatus suitable for vapor depositing the release agent onto the surface of the mold.

### BEST MODES FOR CARRYING OUT THE INVENTION

Reference is made now in detail to specific embodiments, which illustrates the best mode presently contemplated by the inventors for practicing the invention. Alternative embodiments are also briefly described as applicable.

As used herein, the term “nano-imprint” in connection with a mold refers to molds having features (e.g., protrusions that define nanoscale features in a polymer layer that are separated by a spacing on the order of less than 100 nanometers (nm). It will be appreciated that the releasing layer can be deposited into a MEMs structure and onto plane surfaces as well. The technique taught herein can be applied to any features that need the releasing property for their application.

The nanoimprinting process itself is provided in greater detail in, for example, U.S. Pat. No. 6,294,450, entitled “Nanoscale Patterning for the Formation of Extensive Wires” and issued on Sep. 25, 2001, to Yong Chen et al; U.S. Pat. No. 6,407,443, entitled “Nanoscale Patterning for the Formation of Extensive Wires” and issued on Jun. 18, 2002, to Yong Chen et al; U.S. Pat. No. 6,432,740, entitled “Fabrication of Molecular Electronic Circuit by Imprinting” and issued on Aug. 13, 2002, to Yong Chen; and U.S. Pat. No. 6,579,742, entitled “Fabrication of Molecular Electronic Circuit by Imprinting” and issued on Jun. 17, 2003, to Yong Chen. The contents of the foregoing references are incorporated herein by reference.

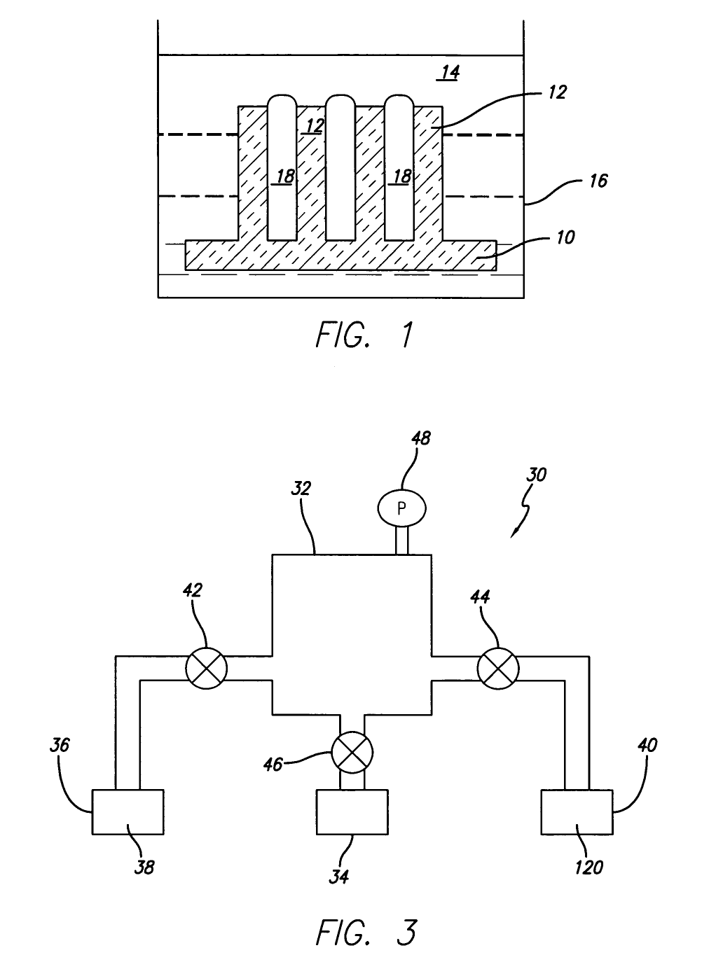

Methods for improving the release properties of molds for nanoimprinting, especially those with high aspect-ratio structures, are provided. Specifically, the vapor of the release agent is used to form the self-assembled monolayer (SAM). As a consequence, problems are avoided that are associated with solution-based coating processes, such as incomplete wetting of confined areas caused by air bubbles that prevent direct contact of solution to the side walls of the gaps (FIG. 1), control of minute quantities of dissolved water in non-aqueous solution, and micelle formation. The vapor of the coupling agent can provide efficient transport into the confined surfaces of the mold, which is crucial for the fabrication of fine structures by nano-imprinting lithography. The vapor-phase treatment is much more effective in dealing nano-scale features.

FIG. 1 is a side elevational view of a mold 10 having features 12, e.g., nanowire patterns, immersed in a solution 14 of a mold release agent. The solution 14 is contained in a container 16. Trapped air bubbles 18 are seen to be formed between the features 12, thus interfering with the formation of the release agent on all surfaces of the mold 10. Vapor treatment with the release agent fills those areas otherwise blocked by liquid release agent.

1. SAM Formation

The molecular tail-groups of the release agents on the mold control the surface properties; relevant considerations are hydrophilic properties vs. hydrophobic and/or polar vs. non-polar nature. In an embodiment, the mold surface is initially hydrophilic and polar to react with the release agent. The release agent, which includes an end group that is hydrophilic to react with the polar substrate, renders the mold surface hydrophobic.

To render the mold surface hydrophobic, trichlorosilane with fluorocarbon chains (tails) appear to significantly decrease the stiction and friction of surfaces compared to those mold surfaces coated with hydrocarbon chains. In one embodiment, perfluorinated carbon end groups may be employed, which apparently tend to confer a Teflon-like property used in antisticking layers. In another embodiment, the three terminal carbons of the tail are perfluorinated. An example of a perfluorinated trichlorosilane is
CF₃—(CF₂)ₘ—(CH₂)ₙ—SiCl₃,
where m ranges from 1 to 100 and n ranges from 1 to 10. In one embodiment, n is 2. In one embodiment, higher values of m may be used, since such higher values tend to increase the hydrophobic properties of the release layer. In another embodiment, lower values of n may be used, since such lower values provide dense packing.

Examples of other mold release agents suitably employed herein include, but are not limited to, the following compounds: 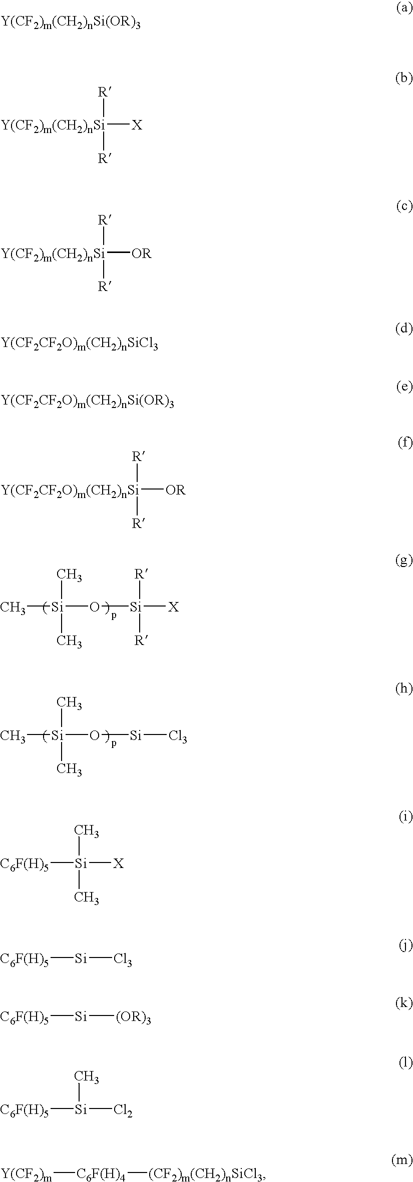
where:
Y=H or F;
m=1 to 100;
n=1 to 10;
R=aliphatic alkyl group or acetyl group;
R′=CH₃, C₂H₅, CH(CH₃)₂, CH₂CH₂CH₂CH₃, CH₂CH(CH₃)₂, C(CH₃)₃;
X=Cl, Br, I, OH, NH₂;
p=0 to 100; and
F(H) indicates that the phenyl ring is at least partially fluorinated and may be perfluorinated.

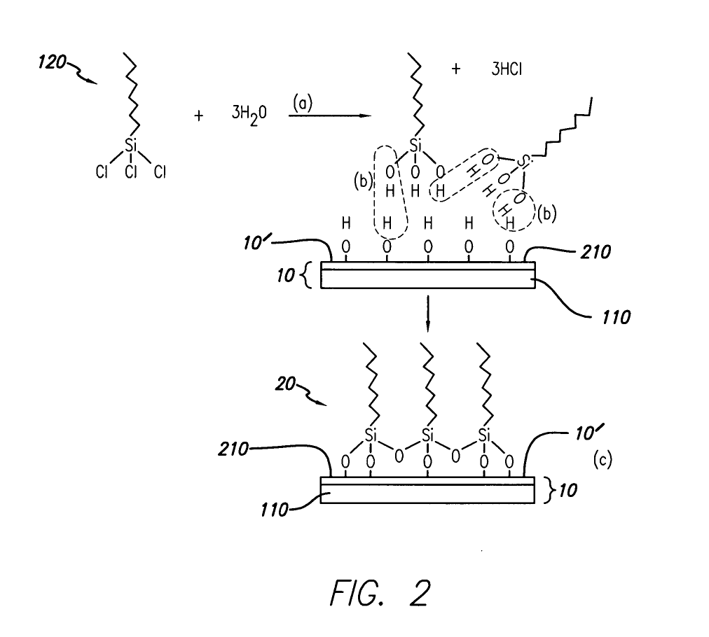

All of the above-listed compounds undergo hydrolysis in the presence of water to generate compounds containing Si—OH groups. This reaction is catalyzed by acid/base either present or generated during the hydrolysis. Further condensation takes place as outlined in FIG. 2, discussed below, to attach hydrophobic moieties to the mold. Whenever one —OH group is present or generated on the silicon atom, the molecule is directly attached to the mold and no further condensation is possible. In the case of multiple hydroxyl groups, neighboring condensation takes place similar to FIG. 2. All of these compounds also exhibit high contact angle with water, thereby suggesting the hydrophobic nature on the surface. All of these compounds also have good release properties similar to that of the example illustrated in FIG. 2, as well as that of polytetrafluoroethylene.

It will be readily appreciated that a mixture of one or more of the silanes listed above may be employed in the practice of the embodiments taught herein, throughout all concentration ranges disclosed.

FIG. 2 shows the formation of a SAM 20 on the mold surface 10′ in the case where the mold 10 is made of Si and/or SiO₂. In alternate embodiments, the mold may comprise glass, quartz, alumina, germanium, germanium oxide, tin, and tin oxide. In the embodiment depicted, the mold 10 comprises a substrate 110 of Si covered with a layer 210 of SiO₂.

The SAM coating 20, or silanization, on the mold 10 begins with the reaction of the coupling agent 120 (mold release agent precursor), for example, perfluroalkyl trichlorosilane, with water, which hydrolyzes the Si—Cl bonds to Si—OH (silanol) groups (reaction denoted “(a)” in FIG. 2). The mold surface 10′ is hydroxylated, such as with a mixture of HCl and H₂O₂, although other hydroxylating reagents that provide a source of —OH groups to react with exposed Si atoms on the silicon-containing substrate may alternatively be used.

The silanols can then hydrogen-bond to the hydroxylated mold surface 10′, and the subsequent condensation reaction, with water as the byproduct, forms a covalent bond, Si—O—Si (the formation of H₂O is indicated by “(b)” in FIG. 2). Interactions between the perfluoroalkyl chains produce a dense monolayer. The same reactions can occur between neighboring molecules, resulting in Si—O—Si bonds within the monolayer. The final SAM is a dense robust film 20, which has a covalent siloxane network both laterally and to the Si substrate 10 (as indicated at “(c)” in FIG. 2).

As an example, in the hydrolysis reaction, 1 mole of the trichlorosilane reacts with 3 moles of water to form 1 mole of trihydroxysilane and 3 moles of HCl. The hydroxylation reaction is carried out, for example, using water. The hydrolysis employed herein utilizes process conditions that are well known for such reactions.

Continuing with the example of the perfluorinated trichorosilane discussed above, the condensation reaction involves the reaction of the silanol with the hydroxylated Si surface.

The final product, bonded to the mold surface 10′, is
CF₃—(CF₂)ₘ—(CH₂)ₙ—SiOₓ,
where m and n are as above and x ranges from 1 to 3, depending on the extent of the condensation reaction (condensation between neighboring —OH groups in the silanol vs. condensation between —OH groups in the silanol and —OH groups on the silicon-containing surface).

The hydrophobic nature of the mold 10 coated with the SAM 20 can be measured quantitatively by water-drop contact angle measurement.

The final product listed above is based on starting with CF₃—(CF₂)ₘ—(CH₂)ₙ—SiCl₃ as the precursor. If one of the other precursor compounds is selected, then only the functional group (OR₃, X, OR, Cl₃, Cl₂) is replaced by Oₓ, where x is as given above.

2. Experimental Set-Up

The apparatus 30 for the vapor deposition is shown in FIG. 3. The apparatus 30 comprises a reaction chamber 32, a pump 34 for drawing a vacuum, a reservoir 36 containing water 38, and a reservoir 40 containing the coupling agent 120 (mold release agent precursor). The water-containing reservoir 36 is connected to the reaction chamber 32 through a valve 42, while the coupling agent-containing reservoir 40 is connected to the reaction chamber 32 through a valve 44.

The mold (e.g., Si and/or SiO₂) 10 is cleaned with a piranha etch solution (e.g., 1 part by volume of 30% H₂O₂ to 3 parts by volume of concentrated H₂SO₄) or other means for cleaning the surface 10′ of the mold and loaded into the reaction chamber 32, which in this case was pumped by a mechanical roughing pump 34 down to 10⁻³ torr. The vacuum should be lower than the vapor pressures of both the coupling agent, or self-assembly material, 120 and deionized water 38 at the temperature of the reaction chamber 32 so that the vapor of both materials can flow into the reaction chamber and reach a static gas pressure. The reaction chamber 32 can be heated by heating means (not shown) in order to control the vapor pressures and also to desorb any unwanted material from the surface 10′ of the mold 10 before deposition of the SAM 20.

The vapor-based coating process begins with pumping the reaction chamber 32 to an appropriate pressure and then closing the pump valve 46. The pressure inside the reaction chamber 32 is read by pressure gauge 48. The vapor of one of the materials (H₂O 38 or perfluoroalkyl trichlorosilane 120, for example), which has the lower vapor pressure, is admitted to the reaction chamber 32 by opening the valve 40, 42 until the pressure of chamber reaches a static pressure. After this, the valve 40, 42 is closed and the reaction chamber 32 can be heated if required to drive a reaction to completion or remove excess reactant from the mold 10. Then, another valve 42, 40 is opened for the vapor of the second material (if required) until a static pressure is obtained. The vapors are left to react with the surface of the mold 10 at a static condition and to form a lateral siloxane network within the monolayer 20. The vapor can reach into confined areas by gas phase and surface diffusion, resulting in highly uniform and dense SAMs 20. The quality of the release layer 20 can be characterized by in situ ellipsometric measurements or by water-drop contact angle measurements.

Water contact angles of a Si mold 10 with an SiO₂ layer (not shown) were measured, comparing the prior art approach of liquid solution coating and the present teachings using vapor phase coating. In the former case, the contact angle measured was 113°, while in the latter case, the contact angle measured was 131°.

From the contact angle measurements, it is seen that the mold surface 10′ treated by vapor phase exposure to the release materials 120 to form the SAM layer 20 is significantly more hydrophobic than that treated in solution, and this difference in surface properties is reflected in the superior performance of the mold when used to imprint patterns into the polymer layer (e.g., smaller force to separate the mold from the substrate, cleaner mold after separation, and the ability to utilize the mold several times without a cleaning step).

SEM images of the mold after imprinting clearly show that for the mold treated in solution, the polymer stuck to the gaps between features, while for the mold treated in vapor in accordance with the present teachings, the polymer did not stick to the gaps.

The vapor-based coating process disclosed herein has several advantages over the solution-based process:
higher quality of SAMs in the confined surfaces of the mold;
elimination of bubble and micelle formation on the mold surface;
more homogeneous SAMs over the surface;
smaller forces required to separate the mold from the film;
no solvent waste, which means a less expensive process that has a lower environmental impact;
enhances the resolution of the image;
protects the mold so that it can be used without showing wear on the fine structures in the mold; and
significantly speeds up the throughput of the nano-imprint process by eliminating the mold cleaning step (the release layer can be reused many times).

While the foregoing description has been directed primarily to mold release agents for nano-imprinting and the release of molds having features thereon from imprinted surfaces, it will be readily appreciated that the same methods used to provide the mold surface with the release agent may be used to provide other surfaces with a release agent, by depositing the self-assembled monolayer from the vapor state. Such methods may be used, for example, in micro electrical-mechanical devices (MEMs), template stripping, and other nano-based technologies involving the use of release agents on surfaces having features thereon, particularly where such features are separated by less than 100 nm.

### INDUSTRIAL APPLICABILITY

The use of vapor phase deposition of release agents onto surfaces having features thereon is expected to find use in various nano-based technology.

What is claimed is:

1. A method for coating a surface having features thereon with a self-assembled monolayer for aiding release of said surface during an imprinting procedure, said process comprising exposing said surface to a vapor of a release agent precursor.

2. The method of claim 1 wherein said features are separated by a distance of less than 100 nm.

3. The method of claim 1 wherein said surface comprises a surface of a nano-imprint mold.

4. The method of claim 3 wherein said mold comprises at least one material selected from the group consisting of Si, SiO₂, glass, quartz, alumina, germanium, germanium oxide, tin, and tin oxide.

5. The method of claim 4 wherein said mold comprises a substrate of silicon and a layer of silicon dioxide thereon.

6. The method of claim 1 wherein said surface of said mold is hydroxylated.

7. The method of claim 1 wherein said release agent precursor comprises a silane.

8. The method of claim 7 wherein said method further comprises:
hydrolyzing said silane to form a silanol; and
condensing said silanol on a surface of said mold.

9. The method of claim 7 wherein said silane is selected from the group consisting of 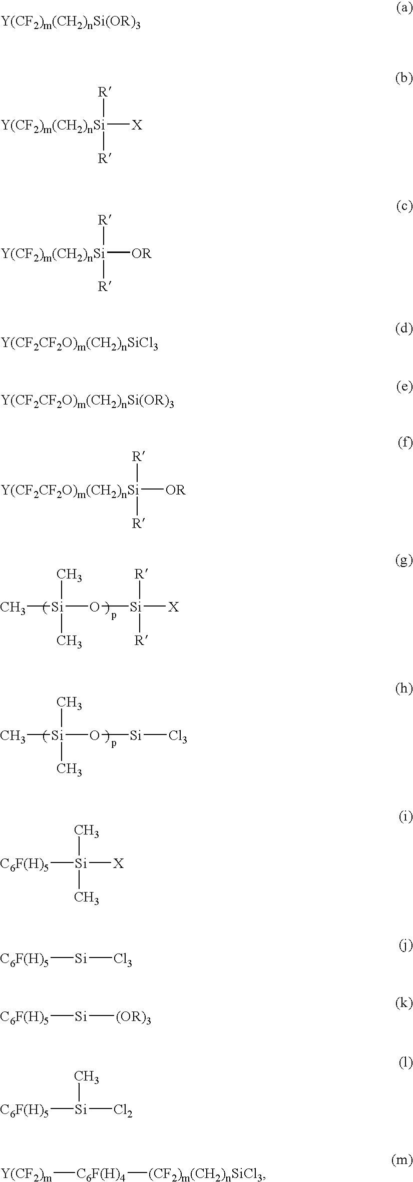
where:
Y=H or F;
m=1 to 100;
n=1 to 10;
R=aliphatic alkyl group or acetyl group;
R′=CH₃, C₂H₅, CH(CH₃)₂, CH₂CH₂CH₂CH₃, CH₂CH(CH₃)₂, C(CH₃)₃;
X=Cl, Br, I, OH, NH₂;
p=0 to 100; and
F(H) indicates at least partially fluorinated.

10. The method of claim 9 wherein said silane is CF₃—(CF₂)ₘ—(CH₂)ₙ—SiCl₃.

11. The method of claim 10 wherein said method further comprises:
hydrolyzing said trichlorosilane to a trihydroxysilane; and
condensing said trihydroxysilane on a surface of said mold.

12. A method for coating a nano-imprint mold with a self-assembled monolayer for aiding release of said mold during an imprinting procedure, said method comprising:
hydroxylating said mold surface;
exposing said mold to a vapor of a mold release agent precursor;
hydrolyzing said mold release agent to form a hydrolysis product; and
condensing said hydrolysis product on a surface of said mold.

13. The method of claim 12 wherein said mold has features separated by a distance of less than 100 nm.

14. The method of claim 12 wherein said mold comprises at least one material selected from the group consisting of Si, SiO₂, glass, quartz alumina, germanium, germanium oxide, tin, and tin oxide.

15. The method of claim 14 wherein said mold comprises a substrate of silicon and a layer of silicon dioxide thereon.

16. The method of claim 12 wherein said release agent precursor comprises a silane.

17. The method of claim 16 wherein said silane is selected from the group consisting of 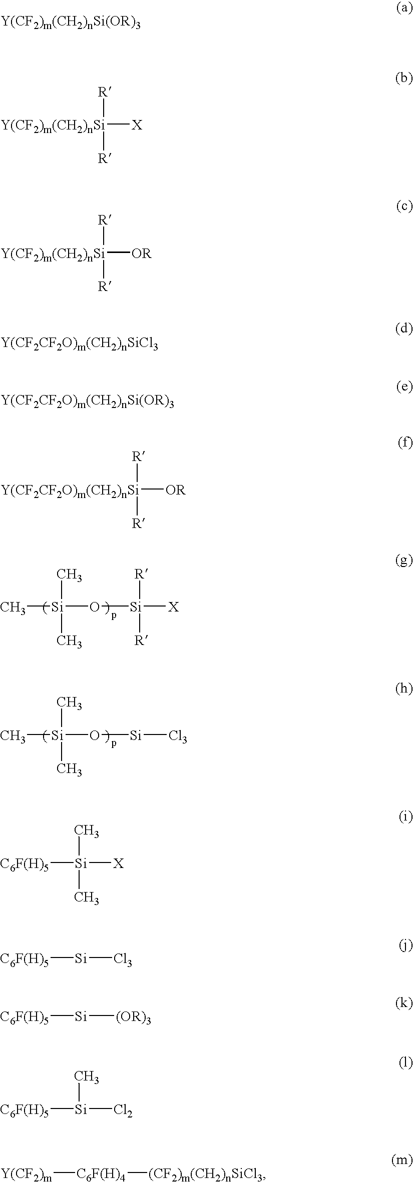
where:
Y=H or F;
m=1 to 100;
n=1 to 10;
R=aliphatic alkyl group or acetyl group;
R′=CH₃, C₂H₅, CH(CH₃)₂, CH₂CH₂CH₂CH₃, CH₂CH(CH₃)₂, C(CH₃)₃;
X=Cl, Br, I, OH, NH₂;
p=0 to 100; and
F(H) indicates at least partially fluorinated.

18. The method of claim 17 wherein said silane is CF₃—(CF₂)ₘ—(CH₂)ₙ—SiCl₃.

19. The method of claim 18 wherein said method further comprises:
hydrolyzing said trichlorosilane to a trihydroxysilane; and
condensing said trihydroxysilane on a surface of said mold.

20. The method of claim 12 wherein said coating is carried out in a reaction chamber.

21. The method of claim 20 wherein said coating is carried out in a vacuum in said reaction chamber.

22. The method of Clam 21 wherein said mold release agent precursor and water both have a vapor pressure and wherein said vacuum is lower than the vapor pressures of both said mold release agent precursor and water.

23. The method of claim 20 wherein said reaction chamber is heated to a temperature so that the vapor of both said mold release agent precursor and said water can flow into the reaction chamber and reach a static gas pressure.

24. A mold provided with a mold release coating comprising a self-assembled monolayer on a surface of said mold.

25. The mold of claim 24 wherein said mold has features separated by a distance of less than 100 nm.

26. The mold of claim 24 wherein said mold comprises at least one material selected from the group consisting of Si, SiO₂, glass, quartz, alumina, germanium, germanium oxide, tin, and tin oxide.

27. The mold of claim 26 wherein said mold comprises a substrate of silicon and a layer of silicon dioxide thereon.

28. The mold of claim 24 wherein said mold release agent coating comprises a vapor-deposited, condensed silane, hydrogen-bonded to said surface of said mold, wherein said surface includes a hydroxylated layer.

29. The mold of claim 28 wherein said condensed silane is derived from a silane selected from the group consisting of: 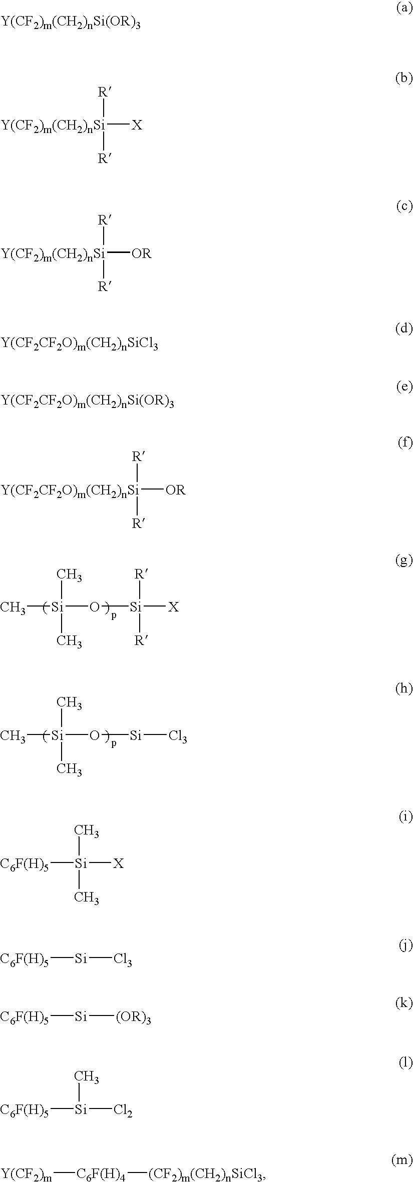
where:
Y=H or F;
m=1 to 100;
n=1 to 10;
R=aliphatic alkyl group or acetyl group;
R′=CH₃, C₂H₅, CH(CH₃)₂, CH₂CH₂CH₂CH₃, CH₂CH(CH₃)₂, C(CH₃)₃;
X=Cl, Br, I, OH, NH₂;
p=0 to 100;
F(H) indicates at least partially fluorinated; and
x=1 to 3.

30. The mold of claim 29 wherein said silane has the formula
CF₃—(CF₂)ₘ—(CH₂)ₙ—SiOₓ.
